(19) United States
(12) Patent Application Publication
(10) Pub. No.: US 2014/0345458 A1
(43) Pub. Date: Nov. 27, 2014

(54) REDUCING NITROSAMINE CONTENT OF AMINE COMPOSITIONS

(71) Applicant: DOW Global Technologies LLC, Midland, MI (US)

(72) Inventor: Eric J. Klinker, Lake Jackson, TX (US)

(21) Appl. No.: 14/345,341

(22) PCT Filed: Sep. 20, 2012
(86) PCT No.: PCT/US12/56226

§ 371 Date: Mar. 17, 2014

Related U.S. Application Data
(60) Provisional application No. 61/538,479, filed on Sep. 23, 2011.

(51) Int. Cl. B01D 53/14

(52) U.S. Cl. CPC B01D 53/1425; B01D 53/1475; B01D 53/1481; B01D 53/1493; B01D 2252/204
USPC 95/186; 204/157.81; 96/234

(57) ABSTRACT

The present invention provides strategies for reducing the nitrosamine content of amine compositions that are contaminated with one or more nitrosamines. The present invention is based apart upon the appreciation that irradiating contaminated amine compositions with a suitable fluence of electromagnetic energy, such as ultraviolet energy, is able to selectively decompose the nitrosamine content relative to the amine content. This allows the amine content of the treated compositions to be preserved. As a consequence, the principles of the present invention are particularly useful for regenerating amine absorbents. Reducing the nitrosamine content so easily also facilitates disposal, further processing, or other desired handling of amine compositions.

### FIELD OF THE INVENTION

The present invention relates to purifying amine compositions, particularly aqueous amine compositions used as absorbents to remove acid contaminants from gas mixtures such as flue gas, natural gas, and the like. More particularly, irradiating aqueous compositions with electromagnetic energy selectively decomposes nitrosamine content relative to amine content to regenerate more pure amine compositions.

### BACKGROUND OF THE INVENTION

It is desirable to be able to remove acid contaminants from a wide variety of fluids. For instance, natural gas contains a number of acidic gaseous components, such as hydrogen sulfide and carbon dioxide, as well as water vapor, which desirably should be removed from the gas before the gas is transported and/or used. Combustion gases, e.g., flue gases, also may contain carbon dioxide, sulfur dioxide, nitrogen oxides and/or other acid contamination that desirably is removed.

These components can be removed from natural gas, and other similar fluids if desired, by contacting the gas in countercurrent flow with an aqueous solution of a gas treating chemical, often an aqueous solution containing one or more of an alkanolamine such as monoethanolamine (MEA), diethanolamine (DEA) or methyl diethanolamine, or a glycol such as mono-, di- or tri-ethylene glycol, or sulfinol. The solution of the gas treating chemical efficiently absorbs the acid components or water from the natural gas. Thereafter, the solution of the gas treating chemical is regenerated by stripping the absorbed acid materials from the solution so that the solution can be recirculated and re-used for the treatment of further natural gas. This stripping operation is often brought about by flowing the solution countercurrent through steam in a regenerator or stripper apparatus.

Over a period of time, contaminants can build up to the extent that the efficiency of removal of the acidic gaseous components is reduced too much and/or the gas treating solution becomes too viscous to pump efficiently. When this occurs, a fresh, aqueous gas treating chemical solution generally replaces the solution. However, this gives rise to two disadvantages. Firstly, the resulting large quantities of waste solution are difficult and expensive to dispose of because of their content of caustic substances. Secondly, the cost of fresh gas treating chemical is quite high, so the overall cost efficiency of the process is reduced. In view of this, attempts have been made to regenerate the used absorbent compositions so that the compositions can be reused.

According to one conventional regeneration technique, regeneration is accomplished by heating the used absorbent. Because the solubility of acidic gases is reduced at higher temperatures, the heating drives out a large portion of the acidic, gaseous contaminants that were absorbed by the absorbent.

However, there are other kinds of contaminants in used absorbent solutions, and merely heating is not generally sufficiently effective to remove these from the absorbent. For example, the nitrosamine content of absorbents may tend to increase in the course of a purification system. It is desirable to reduce nitrosamine content of the absorbents, because build-up of appreciable amounts of nitrosamine can result in low levels of nitrosamines in the vapor phase or in the treated gas and can also complicate the handling of aqueous amines. Removal of nitrosamines can make it easier to recycle, discard, further process, or otherwise handle the absorbent streams. However, removal of nitrosamines selectively relative to the desirable amines is problematic because both kinds of materials are highly soluble in each other as well as in aqueous solutions.

Thus, there is a strong demand for strategies for purifying amine compositions that can selectively remove nitrosamines relative to amines.

### SUMMARY OF THE INVENTION

The present invention provides strategies for reducing the nitrosamine content of amine compositions that are contaminated with one or more nitrosamines. The present invention is based apart upon the appreciation that irradiating contaminated amine compositions with a suitable fluence of electromagnetic energy, such as ultraviolet energy, is able to selectively decompose the nitrosamine content relative to the amine content. This allows the amine content of the treated compositions to be preserved. As a consequence, the principles of the present invention are particularly useful for regenerating amine absorbents. Reducing the nitrosamine content so easily also facilitates disposal, further processing, or other desired handling of amine compositions.

In one aspect, the present invention relates to a method of reducing the nitrosamine content of a composition including at least one nitrosamine and one or more amines, comprising the steps of:

(a) providing the composition, wherein the composition has an initial nitrosamine content and an initial amine content;

(b) irradiating the composition with a fluence of electromagnetic energy under conditions effective to cause selective decomposition of at least a portion of the initial nitrosamine content relative to the initial amine content.

In another aspect, the present invention relates to a method of removing contaminants from a gas mixture, comprising the steps of:

(a) using an aqueous amine composition to remove at least a portion of one or more contaminants included in a gas mixture, wherein said using step provides a purified gas mixture with a reduced contaminant content and a rich aqueous amine composition comprising one or more of the contaminants and one or more by-product nitrosamines

(b) treating the rich amine composition under conditions effective to provide a lean amine composition, said treating comprising:
(i) removing at least a portion of the contaminants from the rich amine solution; and
(ii) irradiating the rich amine composition with a fluence of electromagnetic energy under conditions effective to cause selective decomposition of at least a portion of the initial nitrosamine content relative to the initial amine content; and

(c) recycling the lean amine composition such that at least a portion of the aqueous composition used in step (a) includes the recycled, lean amine solution.

In another aspect, the present invention relates to a purification system for removing at least one acid contaminant from a contaminated fluid stream, said system comprising:

a) an absorbent comprising at least one amine;

b) a purifying stage occurring in one or more treatment units in which a flow of the absorbent is caused to contact the contaminated fluid stream under conditions such that at least a portion of the one or more acid gas contaminants are removed from the fluid stream and incorporated into the flow of the absorbent to cause a downstream flow of the absorbent that exits the purifying stage to be acid-enriched relative to the flow of the absorbent that is introduced into the purifying stage, and wherein the downstream flow of the absorbent that exits the purifying stage further comprises a nitrosamine content;

c) a regeneration stage comprising:
(i) a first portion in which at least a portion of the downstream flow of the absorbent that exits the purifying stage is treated under conditions effective to remove at least a portion of the acid contaminant from the flow of the absorbent to cause the flow of the absorbent that exits the regeneration stage to be acid-lean relative to the flow of the absorbent that enters the regeneration stage; and
(ii) a second portion comprising at least one electromagnetic energy source operatively incorporated into the second portion in a manner effective such that a fluence of electromagnetic energy emitted from the energy source irradiates at least a portion of the downstream flow of the absorbent that exits the purifying stage to cause decomposition of at least a portion of the nitrosamine content in the downstream flow; and

d) one or more fluid pathways coupling the regeneration stage to the purifying stage in a manner to allow the absorbent treated in the first and second portions of the regeneration stage to be recycled for use as at least a portion of the flow of the absorbent used to contact the contaminated fluid stream in the purifying stage.

### BRIEF DESCRIPTION OF THE DRAWINGS

The above mentioned and other advantages of the present invention, and the manner of attaining them, will become more apparent and the invention itself will be better understood by reference to the following description of the embodiments of the invention taken in conjunction with the accompanying drawings, wherein:

FIG. 1 is a schematic illustration of a purification system incorporating principles of the present invention in which an absorbent such as an amine solution is used to remove acid contaminants, such as CO₂, SO₂, and/or the like, from a contaminated fluid, such as flue gas, and in which irradiation strategies are used to help regenerate the absorbent; and

FIG. 2 is a graph that shows amine and nitrosamine content as a function of UV exposure time for an amine composition contaminated with nitrosamine and treated in the Example, below.

### DETAILED DESCRIPTION OF PRESENTLY PREFERRED EMBODIMENTS

The embodiments of the present invention described below are not intended to be exhaustive or to limit the invention to the precise forms disclosed in the following detailed description. Rather the embodiments are chosen and described so that others skilled in the art may appreciate and understand the principles and practices of the present invention.

The present invention provides strategies to reduce the nitrosamine content of compositions including at least one amine and at least one nitrosamine. The strategies are selective for reducing nitrosamine content relative to amine content in the sense that the percentage reduction of the nitrosamine content is greater than the percentage reduction of the amine content.

According to a representative mode of practice, an amine composition is provided that comprises at least one amine and also contains at least one nitrosamine (also referred to as an N-nitrosamine) as a contaminant. As used herein, the term “amine” refers to an organic compound that includes at least one amine moiety, preferably at least two amine moieties, more preferably at least three amine moieties, and even more preferably at least four amine moieties. For purposes of the present invention, a nitrosamine shall not be considered to be an amine. Amines that include two or more amine moieties are referred to herein as polyamines. An organic compound as used herein refers to a compound that includes at least one carbon atom and at least one hydrogen atom that is covalently bound to a carbon atom or that is covalently bound to an oxygen atom that is covalently bound to a carbon atom. The amine compounds may be linear, branched, cyclic, or acyclic, saturated, unsaturated, aliphatic, and/or aromatic. The amine moieties can be primary, secondary, and/or tertiary. In addition to amine functionality, such compounds may also include other functionality such as OH, CO₂H or salts thereof, SO₃H or salts thereof, PO₃H₂ or salts thereof, halides, alkoxy groups, thiol groups, ester groups, ketone groups, ammonium, urethane, urea, amides, aldehydes, combinations of these and the like.

The amine functionality can be sterically hindered or non-hindered. A sterically hindered amine is defined structurally as a primary amine in which the amino group is substituted by a tertiary carbon, or a secondary amine in which the amino group is substituted with a secondary or tertiary carbon.

An exemplary class of amines includes hydrocarbyl amines. This kind of amine includes at least one hydrocarbyl moiety and at least two amine moieties. The term “hydrocarbyl” refers to a moiety in which C and H atoms constitute at least 50 weight percent, preferably at least 60 weight percent, more preferably at least 80 weight percent, and even more preferably 100% of the moiety. In addition to C and H, such moieties may include other atoms such as O, covalently bound halogen such as bromo atoms, P, S, combinations of these and the like. Hydroxy-functional alkyl or alkylene moieties are examples of hydrocarbyl moieties including one or more O atoms. The hydrocarbyl moieties independently may be acyclic or cyclic; branched or linear; saturated or unsaturated; aliphatic or aromatic; or combinations of these.

Preferred hydrocarbyl moieties are independently divalent, trivalent, tetravalent, pentavalent, and/or hexavalent alkylene moieties of 1 to 50, preferably 1 to 20, more preferably 1 to 10, and even more preferably 2 to 6 carbon atoms. If other kinds of atoms are present in the alkylene moieties, desirably these are incorporated into moieties that are substantially inert with respect to the process conditions used in the purification methods of the present invention.

Specific examples of amines include monoethanolamine (MEA), diethanolamine (DEA), triethanolamine (TEA), ethylene diamine (EDA), 1,3-diaminopropane (1,3-DAP), diethylenetriamine (DETA), triethylenetetramine (TETA), tetraethylenepentamine (TEPA), pentaethylenehexamine (PEHA), piperazine (PIP), aminoethylpiperazine (AEP), h-piperazine (h-PIP), amino ethylethanolamine (AEEA), methyldiethanol amine, diisopropanol amine, combinations of these, and the like.

Amine compositions containing at least one amine and at least one nitrosamine can be obtained from a variety of sources. One exemplary source is an amine composition used as an absorbent in a purification system. Generally, fluid amine compositions have the ability to absorb (also referred to as stripping) acid contaminants from another fluid when the absorbent and the other fluid are in contact with each other. A wide range of contaminated fluids may be purified using amine absorbents. Examples of fluids that may be purified include hydrogen, hydrocarbons, flue gas and other gases resulting from fuel burning, waste burning, and the like. Acid contaminants include one or more species such as carbon dioxide, SO₂, SO₃, H₂S, mercaptans, NO, NO₂, combinations of these, and the like. Some of the acid contaminants themselves have industrial utility and may be recovered for future use if desired after being removed from the contaminated fluids.

After absorbing contaminants from the contaminated fluid feed being purified, a purified fluid with a reduced acid contaminant content is produced. The absorbent, having absorbed those acid contaminants, becomes relatively rich in the acid gas(es) stripped from the now purified fluid. In addition, the purification treatment also causes an increase in the nitrosamine content of the amine absorbent composition. Without wishing to be bound, it is believed that nitrosamine(s) may be produced as by-products when one or more secondary amine constituents of the amine composition react with nitrogen oxide constituents of the fluid being purified. The principles of the present invention are particularly useful for reducing the nitrosamine content as part of a regeneration strategy so that the regenerated amine composition can be further processed, discarded, or more preferably recycled to carry out further purification of the contaminated fluid feed.

A nitrosamine is a compound that is a derivative of an amine in which a nitroso moiety (—N═O) is bonded to the nitrogen of an amine. Without wishing to be bound, it is believed that a nitrosamine forms when a secondary amine reacts with a nitrogen oxide as a nitrosating agent. An exemplary nitrosamine has the formula

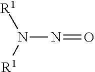

wherein each R¹ is a monovalent moiety or a co-member of a ring structure with the other R¹ group that may be an aryl or non-aryl moiety that is linear, branched, cyclic, polycyclic, fused ring, or the like. R¹ may be saturated or unsaturated. R¹ may be substituted or unsubstituted. If optionally substituted, exemplary substituents may include one or more halides, alkoxy groups, hydroxy groups, thiol groups, ester groups, ketone groups, carboxylic acid groups or salts thereof, sulfate, sulfonate, phosphate, phosphonate, amines, urethane, urea, amides, combinations of these, and the like. If R¹ has a backbone or pendant moieties that include 1 or more C atoms, the backbone or such moieties independently may include one or more heteroatoms.

In other embodiments, a nitrosamine may include more than one nitrogen atom bonded to a nitroso group such as the following formula:

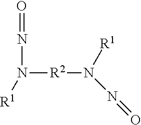

wherein each R¹ is independently a moiety as defined above, and wherein each R² independently is a divalent linking group that may be an aryl or non-aryl moiety that is linear, branched, cyclic, polycyclic, fused ring, or the like. R¹ may be saturated or unsaturated. R² may be substituted or unsubstituted. If optionally substituted, exemplary substituents may include one or more halides, alkoxy groups, hydroxy groups, thiol groups, ester groups, ketone groups, carboxylic acid groups or salts thereof; sulfate, sulfonate, phosphate, phosphonate, amines, urethane, urea, amides, combinations of these, and the like. If R² has a backbone or pendant moieties that include 1 or more C atoms, the backbone or such moieties independently may include one or more heteroatoms.

The amine composition optionally may include one or more solvents. In many situations, the solvent comprises water, and the amine compositions are aqueous solutions or dispersions, preferably aqueous amine solutions. In addition to water, such aqueous solutions optionally may include one or more co-solvents such as ethanol or the like. Aqueous solutions comprising one or more alkanolamines are more preferred. In typical modes of practice, aqueous amine solutions include from 10 to 70 weight percent, preferably 30 to 60 weight percent, more preferably 40 to 55 weight percent amine based on the total weight of the composition. If an additional co-solvent is included, the weight ratio of the water to the co-solvent may be in the range from 2 to 25, preferably 2.8 to 10, more preferably 3 to 8. After being used as an absorbent to purify a contaminated gas mixture, the amine composition often may include from 0.002 to 0.04, sometimes 0.04 to 0.1, and even sometimes 0.1 to 0.2 parts by weight of nitrosamine per 100 parts by weight of all the amines included in the amine composition.

In addition to one or more amines, one or more nitrosamines, and optionally solvent, the amine compositions of the present invention optionally may include one or more additional ingredients. These include organic anions derived from amine or alkanolamine oxidation, inorganic ions from flue gas contaminants, metal contaminants from coal combustion, and heat stable amine salts.

To reduce the nitrosamine content relative to the amine content, the amine composition is irradiated with a fluence of electromagnetic energy under conditions effective to cause selective decomposition of the nitrosamine content relative to the amine content. Previously, it has been known that ultraviolet energy, for instance, can cause nitrosamine compounds to decompose. What is surprising is that irradiation of compositions containing both nitrosamine material and amine material can be irradiated in a way that selectively decomposes the nitrosamine content relative to the amine content. This discovery allows irradiation to be used as part of a regeneration strategy for recycling amine absorbent compositions.

As used herein, “decomposition” means that a species is converted to one or more species of lower average molecular weight than that of the starting species. In the practice of the invention, decomposition encompasses bond breaking, forming new bonds, reactions between two or more species, intraspecies reactions, combinations of these, and the like.

Electromagnetic energy used in the practice of the present invention can be any electromagnetic energy that causes the nitrosamine content to decompose selectively relative to the amine content under the desired temperature and pressure conditions in a reasonable time period. Ultraviolet energy is most preferred as providing excellent selectivity for nitrosamine decomposition relative to amines. Ultraviolet energy includes energy in the UV-A regime (400 nm to 315 nm), the UV-B regime (314.99 nm to 280 nm), and the UV-C regime (270.99 nm to 100 nm). The UV-A and UV-C regimes are more preferred. In one experiment, ultraviolet energy in the UV-C regime having a maximum intensity at 254 nanometer was found to be suitable. In another example, ultraviolet energy in the UV-A regime having a maximum intensity at 365 nanometer was found to be suitable. It also would be suitable to use broadband light sources such as those including maxima in two or more of the UV-A, UV-B, and/or UV-C regions, preferably maxima in at least the UV-A and UV-C regions.

The fluence of the electromagnetic energy refers to the amount of energy (in units of watts, milliwats, etc.) per unit area (e.g., in units of m², cm², etc.) being radiated. A suitable fluence of electromagnetic energy may be selected from a wide range. However, if the fluence is too low, then the treatment may not decompose the nitrosamine and/or a desired degree of decomposition may occur to slowly. On the other hand, if the intensity is too high, it is possible that the selectivity for nitrosamine decomposition may be unduly compromised. Balancing such factors, an exemplary fluence of ultraviolet energy would have a maximum intensity at 254 nm in the range from 1 microW/cm² to 30,000 microW/cm². In specific embodiments, 2 microW/cm² and 200 microW/Cm² would be suitable.

The irradiation treatment generally occurs for a time period effective to decompose at least a portion of the nitrosamine content selectively relative to the amine content. Generally, time periods in the range from 15 seconds to 50 hours, preferably 30 seconds to 5 hours, more preferably 1 minute to 30 minutes would be suitable.

The irradiation treatment desirably occurs at a temperature effective to decompose at least a portion of the nitrosamine content selectively relative to the amine content. If the temperature is too low, then solution viscosity could increase. On the other hand, if the temperature is too high, then decomposition rates of the amines could be increased. Ideally, additional heating or cooling units are not required prior to ultraviolet treating. Balancing such concerns, temperatures in the range from 20° C. to 90° C., preferably 25° C. to 70° C., more preferably 30° C. to 60° C. would be suitable.

The irradiation treatment desirably occurs at a pressure effective to decompose at least a portion of the nitrosamine content selectively relative to the amine content. In many embodiments, the treatment desirably occurs at ambient pressure or at a pressure that is slightly reduced relative to ambient pressure, e.g., in the range of 80% to 99%, preferably 85% to 98%, more preferably 90% to 97% of ambient pressure.

In some modes of practice, irradiation may occur in a single stage in which a flow of the amine composition being treated flows through a fluence of the electromagnetic energy. For longer residence times, two or more irradiation stages may be used. As another approach, a portion of the amine composition leaving the irradiation unit is recycled back to the inlet to the irradiation unit. With such a recycle loop, the average volume portion is recycled one or more times through the irradiation fluence before being transported further downstream for further processing, disposal, recycling to an absorber unit where the regenerated composition can be re-used for purification, sale, or other desired handling.

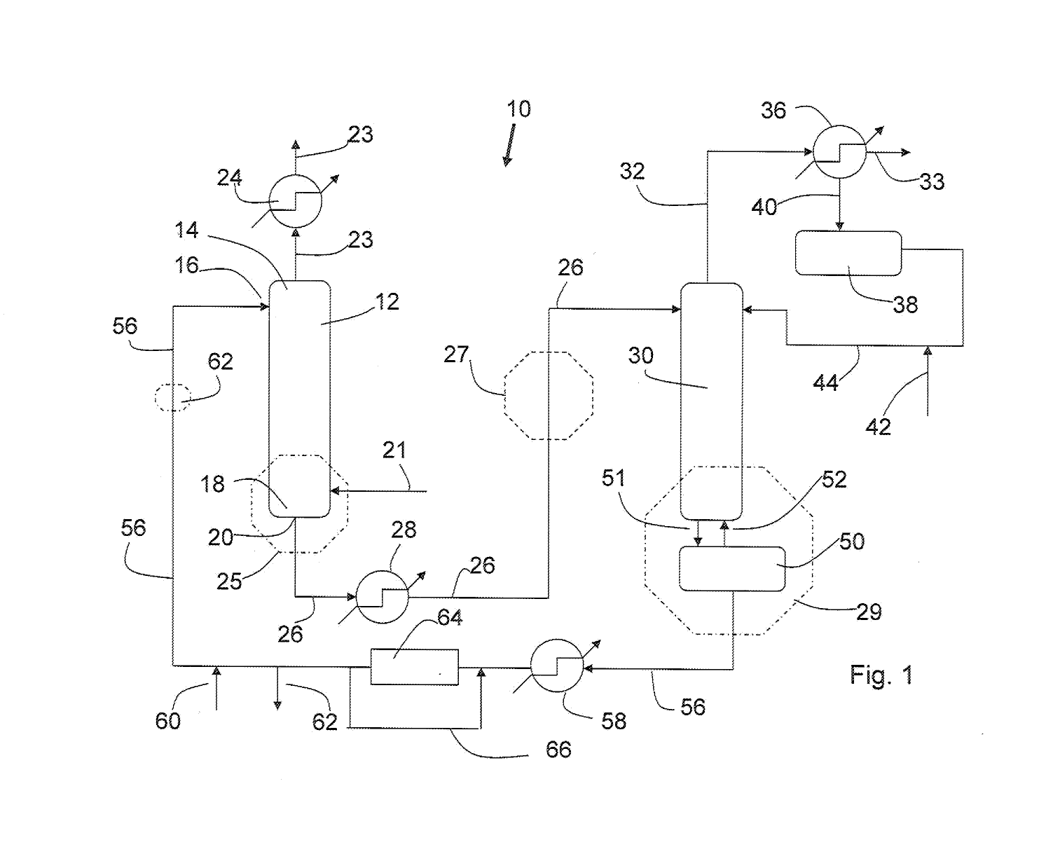

The present invention can be used to reduce the nitrosamine of any kind of amine composition in which it is desired to reduce nitrosamine content while preserving amine content. The invention is particularly useful when incorporated into a purification system that uses an amine composition as an absorbent to help purify contaminated fluids. For example, FIG. 1 schematically illustrates an exemplary purification system 10 incorporating principles of the present invention.

System 10 generally includes a purification stage in which an amine composition functions as a lean absorbent having an activity to absorb one or more acid contaminants in a contaminated fluid. As appreciated by the present invention, many such absorbents may also tend to absorb oxygen and/or oxides of nitrogen from the contaminated fluid. Additionally, such an absorbent also may absorb oxygen and/or oxides of nitrogen from the ambient environment in the purifying stage as well.

For purposes of illustration and convenience, system 10 will now be described in which the absorbent is an aqueous solution comprising at least water as a solvent and one or more amines dissolved in the solvent, and this absorbent is being used to remove the acid gases such as carbon dioxide and the like from contaminated flue gas. It will be understood that this description also applies to other absorbents and contaminated fluids as well. Absorbents in the form of aqueous amine solutions often include from about 10 to 60 weight percent of amine(s) based on the total weight of the solution.

System 10 typically involves introducing lean amine solution and the contaminated fluid into the processing unit 12. The amine solution is caused to contact the contaminated fluid in the first processing unit 12 in a manner that is effective to cause mass transfer of the acid contaminant(s) from the contaminated fluid to the amine solution. The acid content of the amine solution increases as a result, yielding a so-called rich amine solution. The nitrosamine content of the amine solution also tends to increase as a result, it is believed, of reactions between secondary amine(s) and nitrogen oxide species. Additionally, the temperature of the amine solution will tend to increase due to the heat of reaction resulting from the treatment. In many embodiments, the first processing unit 12 is in the form of a processing unit referred to as an absorber. This kind of unit also may be referred to as a scrubbing unit.

Optionally, the contaminated fluid may be pre-treated in one or more ways prior to or after being treated in unit 12. For example, the contaminated fluid may be pre-treated to reduce or remove flue gas contaminants such as fly ash, SO₂, and NOₓ gases using conventional practices.

FIG. 1 illustrates purification stages including a single processing unit 12 in which the absorbent is used to contact and purify the contaminated fluid. In other modes of practice, the purification stage may include a plurality of treatments units in which this purifying action takes place. The multiple units may be the same or different. In other embodiments, membranes may be used in addition to absorbing units and/or as an alternative to scrubbing units.

In many instances, the contact between the amine solution and the contaminated fluid occurs in unit 12 in counter-current fashion as shown in FIG. 1. The lean absorbent enters the first processing unit 12 at a first end 14 via inlet 16. After having absorbed acid contaminants from the fluid-being treated, the resultant rich absorbent exits the first processing unit 12 at a second end 18 via an outlet 20. The contaminated fluid moves through unit 12 in the opposite direction. Via pathway 21, the contaminated fluid enters the first processing unit 12 at second end 18 and exits in more pure form from first end 14 via pathway 23. When the purified fluid is a gas, the purified gas might entrain vaporized solvent, water vapor, or the like. It may be desirable to separate the purified gas from such entrained components. Consequently, the purified gas may be directed to condenser 24, where the vaporized solvent or water vapor exiting the unit 12 is condensed.

As used herein, the term “lean” with respect to an absorbent shall mean that the concentration of acid contaminants (and desirably the oxygen concentration) in the absorbent is sufficiently low such that mass transfer of acid contaminant (and desirably oxygen) from the fluid being treated to the absorbent will occur when the absorbent and contaminated fluid are contacted. In many embodiments, a lean absorbent includes a regenerated amine solution that has been treated to remove nitrosamine and/or acid content from a rich amine solution, optionally fresh absorbent introduced to the system that has not yet been used for purification, and/or a combination of these. “Fresh amine solution” shall refer to amine solution that is being introduced into the purification system 10 for the first time from a suitable source. Fresh amine solution also is lean with respect to acid contaminants and optionally oxygen and may be lean with respect to nitrosamine. The term “rich” with respect to an absorbent shall refer to an amine solution that has picked up acid contaminants relative to the lean amine solution during the course of a purification treatment or for which the nitrosamine content increased in the course of such a treatment.

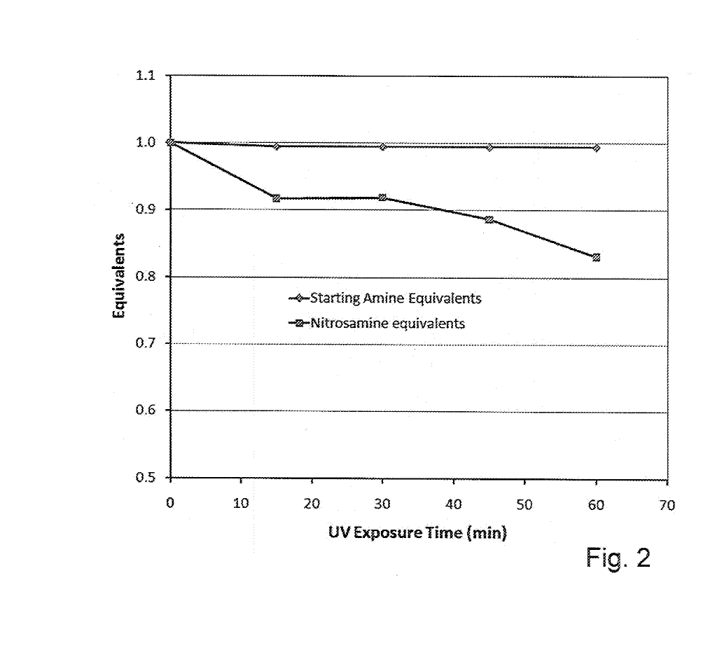

After the rich amine solution exits the first processing unit 12, it is desirable to regenerate the solution so that the solution can be recycled back to the first processing unit 12 for more cycle(s) of treatment. Accordingly, a first pathway 26 is used to convey the rich amine solution to a heating unit 28, where the absorbent is heated to an appropriate temperature before being introduced to a regeneration stage in which lean absorbent is regenerated from the rich absorbent. For purposes of illustration, FIG. 1a shows (and FIG. 2a below) show a regeneration stage 29 that includes as a first portion a single stripper column 30 and a corresponding reboiler 50 and as a second portion an ultraviolet treatment unit 64. In other modes of practice, the first portion of the regeneration stage may include a plurality of stripper units and/or reboiler units in which corresponding regeneration action takes place. Also, the second portion of the regeneration stage also may include a plurality of ultraviolet treatment units 64. The multiple units may be the same or different. Other kinds of regeneration equipment can be used to help regenerate lean amine solution if desired. For instance, flash tanks could be used instead of a stripper column or even in combination with the stripper column 30 and the ultraviolet treatment unit 64.

As shown in FIG. 1, first pathway 26 is used to convey the rich amine solution from heater 28 to an upper portion of stripper column 30. The amine solution then is treated in stripper column 30 by contacting the amine solution with steam or other heat source to heat the amine solution. Generally, the solubility of dissolved acid gases, as well as oxygen, tends to decrease as the temperature of the solution increases. Thus, heating the amine solution in the stripper column 30 strips away these contaminants to provide an amine solution that is more lean with respect to these contaminants.

Stripped acid contaminants exit the top of the stripper column 30 via line 32 and are directed to a condenser 36. In condenser 36, absorbent, water vapor, and other compounds that may leave the top the stripper column 30 together with stripped acid contaminants are condensed. The stripped acid contaminants are discharged from the condenser to line 33 for further down stream processing as desired. Condensed absorbent, water vapor, and/or other compounds that may have condensed are passed to a water receiver 38 via line 40. Line 42 provides a convenient route to introduce fresh water into system 10. Condensed water vapor is refluxed via line 44 to the stripper column 30 from the receiver 38 is used to aid in stripping the acid contaminants from the amine solution being regenerated.

Absorbent leaving the bottom of the stripper column through line 51 passes to a reboiler 50 which is connected back to the stripper column by return line 52. Amine solution circulating through the reboiler 50 and stripper column 30 will have an extended residence time in these units until a portion of the solution exits reboiler 50 via line 56 to be returned to first processing unit 12. Line 56 includes the ultraviolet treatment unit 64 in which the solution is irradiated with a fluence of ultraviolet energy effectively to selectively decompose the nitrosamine content. The unit may include physical means, such as a mixing blade, to mix the contents to help ensure thorough exposure to the energy. Mixing also may occur by directing acoustic energy into the unit. The ultraviolet light source(s) (not shown) may be external to the pathway(s) of unit 51 through which solution is conveyed. The energy can be directed into these pathways through uv-transparent media such as quartz.

An optional recyle line 66 recycles a portion of the solution leaving unit 64. This has the effect of increasing the average residence time that the solution is irradiated. Generally, as the proportion of the solution recycled via line 66 increases, the average residence time in the unit 64 increases. As a consequence of treatment in unit 64, the solution becomes more lean with respect to nitrosamine while the amine content is substantially preserved.

A cooling unit 58 is incorporated into line 56 upstream from unit 64 to cool the lean amine solution prior to the solution being introduced to unit 64. In many instances, cooling unit 58 and heater 28 can also be the same piece of equipment (not shown), e.g., a cross-exchanger. Using a cross-exchanger approach, the hot solution leaving reboiler 50 via line 56 heats up the solution being transported to the stripper column 30 via line 26, while the relatively cooler solution being conveyed to the stripper column 30 in line 26 cools the relatively hot solution leaving reboiler 50 in line 56. Optionally, line 60 provides a convenient location to introduce fresh amine solution to system 10. Amine solution may be drained from system 10 via drain line 62.

The principles of the present invention will now be described with respect to the following illustrative Example.

### EXAMPLE

An aqueous amine solvent for use in CO₂ capture is spiked with 1000 ppmw of N-nitrosamines. The solvent is sent to a chamber containing a UV light source. The light source has an irradiance of 30,000 mW/cm² at 254 nm. The amine and nitrosamine content is shown as a function of UV exposure time in FIG. 2. FIG. 2 shows that exposure to UV light degraded the nitrosamine with minimal impact on the starting amine concentration according to GC analysis of the solution.

The complete disclosures of the patents, patent documents, and publications cited herein are incorporated by reference in their entirety as if each were individually incorporated. Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

1. A method of reducing the nitrosamine content of a an absorbent composition including at least one acid contaminant, at least one nitrosamine, and one or more amines, comprising the steps of:
(a) providing the absorbent composition, wherein the composition has an initial nitrosamine content and an initial amine content;
(b) heating the absorbent composition to provide a lean absorbent composition that is more lean with respect to the at least one acid contaminant;
(c) cooling the lean absorbent composition
(d) irradiating the cooled absorbent composition with a fluence of electromagnetic energy under conditions effective to cause selective decomposition of at least a portion of the initial nitrosamine content relative to the initial amine content.

2. A method of removing contaminants from a gas mixture, comprising the steps of:
(a) using an aqueous amine composition to remove at least a portion of one or more contaminants included in a gas mixture; wherein said using step provides a purified gas mixture with a reduced contaminant content and an aqueous amine composition comprising one or more of the contaminants and one or more by-product nitrosamines
(b) treating the amine composition under conditions effective to provide a lean amine composition, said treating comprising:
(i) removing at least a portion of the contaminants from the amine composition; and
(ii) irradiating the amine composition with a fluence of electromagnetic energy under conditions effective to cause selective decomposition of at least a portion of the initial nitrosamine content relative to the initial amine content; and
(c) recycling the lean amine composition such that at least a portion of the aqueous composition used in step (a) includes the recycled, lean amine solution.

3. The method of claim 2, wherein the amine composition comprises at least one hydrocarbyl amine comprising at least two amine moieties and at least one hydrocarbyl moiety.

4. The method of claim 3, wherein the amine comprises 2 to 8 amine moieties, 1 to 6 hydrocarbyl moieties, and 1 to 4 hydroxyl moieties.

5. The method of claim 3, wherein the amine is selected from the group consisting of monoethanolamine (MEA), diethanolamine (DEA), triethanolamine (TEA), ethylene diamine (EDA), 1,3-diaminopropane (1,3-DAP), diethylenetriamine (DETA), triethylenetetramine (TETA), tetraethylenepentamine (TEPA), pentaethylenehexamine (PEHA), piperazine (PIP), aminoethylpiperazine (AEP), h-piperazine (h-PIP), aminoethylethanolamine (AEEA), methyldiethanol amine, diisopropanol amine, and combinations of these.

6. The method of claim 2, wherein the gas mixture comprises a flue gas.

7. The method of claim 2, wherein the nitrosamine has the formula 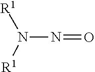
wherein each R¹ independently is a monovalent moiety or a co-member of a ring structure with the other R¹ group.

8. The method of any of claim 2, wherein the nitrosamine has the formula 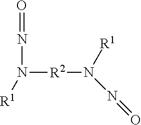
wherein each R¹ is independently is a monovalent moiety or a co-member of a ring structure with the other R¹ group, and wherein R² is a divalent linking group.

9. The method of claim 2, wherein the electromagnetic energy comprises ultraviolet light having a maximum in the UV-A regime.

10. The method of claim 2, wherein the electromagnetic energy comprises ultraviolet light having a maximum in the UV-C regime.

11. The method of claim 2, wherein the electromagnetic energy comprises ultraviolet light having a maximum in the UV-A regime and a maximum in the UV-C regime.

12. The method of claim 2, wherein the electromagnetic energy comprises ultraviolet light having maxima in at least two of the UV-A regime (400 nm to 315 nm), the UV-B regime (314.99 nm to 280 nm), and the UV-C regime (279.99 nm to 100 nm).

13. The method of claim 2, wherein the irradiating occurs at a pressure that is in the range from 80% to 99% of ambient pressure.

14. A purification system for removing at least one acid contaminant from a contaminated fluid stream, said system comprising:
a) an absorbent comprising at least one amine;
b) a purifying stage occurring in one or more treatment units in which a flow of the absorbent is caused to contact the contaminated fluid stream under conditions such that at least a portion of the one or more acid gas contaminants are removed from the fluid stream and incorporated into the flow of the absorbent to cause a downstream flow of the absorbent that exits the purifying stage to be acid-enriched relative to the flow of the absorbent that is introduced into the purifying stage, and wherein the downstream flow of the absorbent that exits the purifying stage further comprises a nitrosamine content;
c) a regeneration stage comprising:
a first portion in which at least a portion of the downstream flow of the absorbent that exits the purifying stage is treated under conditions effective to remove at least a portion of the acid contaminant from the flow of the absorbent to cause the flow of the absorbent that exits the regeneration stage to be acid-lean relative to the flow of the absorbent that enters the regeneration stage; and
(ii) a second portion comprising at least one electromagnetic energy source operatively incorporated into the second portion in a manner effective such that a fluence of electromagnetic energy emitted from the energy source irradiates at least a portion of the downstream flow of the absorbent that exits the purifying stage to cause decomposition of at least a portion of the nitrosamine content in the downstream flow; and
d) one or more fluid pathways coupling the regeneration stage to the purifying stage in a manner to allow the absorbent treated in the first and second portions of the regeneration stage to be recycled for use as at least a portion of the flow of the absorbent used to contact the contaminated fluid stream in the purifying stage.
